(19) United States
(12) Patent Application Publication
(10) Pub. No.: US 2019/0230870 A1
(43) Pub. Date: Aug. 1, 2019

(54) Winter Cover System for Bamboo

(71) Applicant: Michael Conrad Shaffer, Fairfax, VA (US)

(72) Inventor: Michael Conrad Shaffer, Fairfax, VA (US)

(21) Appl. No.: 15/881,738

(22) Filed: Jan. 27, 2018

(51) Int. Cl. A01G 13/04; A01G 13/02; A01G 22/60

(52) U.S. Cl. CPC A01G 13/043; A01G 2013/002; A01G 22/60; A01G 13/0225

(57) ABSTRACT

The following invention is a system for protecting tall bamboo plants from winter weather. The system includes several improvements over existing plant covers. It uses a simple method involving a vertical funnel for covering bamboo. A two-piece funnel is clamped around the base of the bamboo. A long strip of fabric with hook and loop on both sides is connected to the bottom of the funnel. The funnel is then pulled by a rope to the top of the bamboo. The hook and loop is fastened around the bamboo while the funnel is raised. A wireless relay allows the funnel and sleeve to be remotely disconnected. For extra cold protection and aesthetic beauty, Christmas lights can easily be included inside the cover.

### TECHNICAL FIELD

The present invention is a system for protecting tall bamboo plants from winter weather.

### BACKGROUND

The growing of bamboo outside of its native habitat is becoming more popular due to the interne. Unfortunately, the weather in the new locale is often too cold or windy for the bamboo to survive. The North East United States is a prime example of a location where people would like to grow bamboo. Arboretums, hotels, zoos and private residences are some common places where bamboo is desired.

Bamboo has a growth habit in which each year the grove gains additional height until the maximum height for that species is achieved. The individual canes themselves do not grow bigger, but each year's new canes are bigger than the previous year's. Typically when bamboo is young, perhaps 10 feet high, it is possible to bend the bamboo over and tarp it. Once the grove starts producing canes that are bigger, tarping becomes impractical for a number of reasons. For example, increased snow loading, increased wind profile, and difficulty of getting the tarp over the plant.

Winter plant cover systems exist for many types of plants. For example, for bushes or shrubs, a cover can be purchased which is easily placed over the plant. However for very tall bamboo plants, this is not possible since there is no easy way to physically reach the top of the plant.

For someone who really wants to protect a very tall bamboo plant, the only real option is somehow wrapping each individual cane. Wrapping each individual cane minimizes the wind cross section, reduces the heating volume and lowers the surface area for snow loading. Some vertical plant wrapping systems exist, but these have their drawbacks when it comes to bamboo.

U.S. Pat. No. 3,747,293A reveals a method of compressing a living tree through a vertically oriented funnel or split ring and then passing a sleeve over the compressed plant.

German Pat. No. DE202006005466U1 reveals a winter cover which is sealed at the ground and pulled upwards compressing the branches without damaging them. It discusses the benefits of a cover which snugly fits the plant, giving cold and wind little opportunity to impact the plant.

German Pat. No. DE202012001881U1 reveals a vertical sleeve where the opposing edges are connected using hook and loop and the top edge is sealed using a drawstring.

The following is a list of a few disadvantages within the current art of plant covers as it pertains to the invention described herein:
Prior art (U.S. Pat. No. 3,747,293A) describes using either a metal ring or a flexible funnel to compress the plant before it enters the cover. Both of these mechanisms have their drawbacks. A metal ring will likely cause damage to the individual bamboo branches as they pass over it. This is because the compressive forces of the ring will be concentrated on a small area of the branch. A flexible funnel for compressing the plant has the downside of being less durable than a rigid one. The current invention utilizes a rigid funnel constructed of high strength polycarbonate plastic, which will stand up to more abuse than a flexible funnel. Additionally, the rigid funnel is heat moulded on a wood form which has been created on a lathe. This means that the funnel is perfectly round and has a very gradual slope from the top to the bottom, which will be as gentle as possible on the plant.
Prior art (U.S. Pat. No. 3,747,293A) reveals a flexible funnel which compresses the plant. However, as to the optical properties of the funnel, no claim is made. The present invention utilizes a clear polycarbonate plastic. A clear funnel has a couple advantages. It allows the user to see through the funnel while attaching it to the base of the plant. This allows any obstructions such as branches to easily be noticed. The second major advantage of a clear funnel is that it allows the funnel to be placed at the exact top of the plant. This means that the user can make sure there is no extra cover material at the top of the plant. Extra cover material could be a problem in a prolonged high winds.
Prior art (U.S. Pat. No. 3,747,293A) uses two ropes to pull the snap-ring or funnel upwards. The present invention uses only one rope. In a bamboo grove this offers some advantages. The base of a bamboo grove can be dense and using two ropes to support the funnel means twice as much possibility of the rope getting caught on something while positioning it. Additionally, having two ropes means having two winches. If the user wishes to use a winch with a wireless control, then this won't be possible if two winches are required. Using a wireless winch makes the entire process of wrapping the bamboo much easier. The wireless remote control can be clipped to one's shirt for easy access, while the user positions the funnel and fastens the hook and loop.
Prior art (U.S. Pat. No. 3,747,293A) does not include a provision for heating the covered plant. The present invention makes it possible to insert a heating element such as a resistance wire or Christmas lights into the enclosure. This is done by attaching the heating element on a short tether to an attachment point on the tool. When the sleeve reaches the top of the plant, the heating element is separated from the attachment point.
The present invention utilizes a drawstring to keep cold air out of the top of the cover. Prior art (German Pat. No. DE202012001881U1) reveals the benefits using a drawstring to seal the top of a plant cover. However, no prior art exists for how to close a drawstring which is far off the ground. The present invention utilizes a trigger mechanism which is activated by a wireless relay. Using a wireless relay greatly simplifies sealing the end of the cover.
Prior art (U.S. Pat. No. 3,747,293A) utilizes either a folding metal ring or a flexible funnel shaped sleeve for shrinking the plant's branches. In the case of a flexible funnel, several connections must be made along the length of the funnel for it to take the shape of a funnel. The present invention utilizes only 4 total latches for holding the funnel together. This is an advantage of using a rigid funnel over a flexible funnel. Less work is required to form the funnel shape.

### METHOD OF USE

The following is a description of the steps involved in using the funnel to cover a bamboo stem. Before the funnel can be used, a pulley must be anchored above the bamboo grove and a rope run up to the pulley and back down to the funnel. The rope is connected to the hole at the top of the funnel. A relatively large (½″) diameter rope is recommended since it will cause less damage to nearby branches. With the tunnel raised to about chest level, the user pulls the funnel close to the base of a bamboo stem. There are four latches, two on each side, which hold the funnel's two sides together. The user unlatches all four latches and pulls the detachable side off the funnel. The user then positions both sides of the funnel together with the bamboo stem inside the funnel, and then closes all four latches. At this point the funnel is secured around the bamboo stem.

Next, the user connects a fabric sleeve to the bottom of the funnel. This is done in several steps. It is important to understand that the funnel is connected to the fabric sleeve for two different purposes. First, the fabric sleeve has two loops permanently sewn on its top end which act as an anchor to secure the fabric sleeve to the funnel temporarily. Second, the fabric sleeve has an elastic drawstring at its top end which, when pulled, will seal the top of the fabric sleeve. These two attachment methods are each connected to a separate release mechanism. The first release mechanism controls the release of the two strings and thus the separation of the fabric sleeve from the funnel. The second release mechanism controls the closure of the elastic drawstring and the release of the elastic drawstring from the funnel.

The two strings which run from the removable side of the funnel to the fixed side of the funnel are run through two loops that are permanently sewn on the ends of the fabric sleeve. The strings run on opposite sides of the funnel. The strings are permanently connected on the removable side of the funnel and temporarily connected on the fixed side of the funnel. The other end of the strings are attached to the first release mechanism.

To configure the second step, the elastic drawstring is tied in a knot and wrapped around the second rotating rod which is controlled by the second linear solenoid. The elastic drawstring is permanently connected to the fabric sleeve, but is only connected to the funnel by the linear solenoid and rotating rod.

After these two steps are complete, the rest is fairly simple. The funnel is pulled upwards by pulling on the rope. The hook and loop fastener is fastened while the funnel is raised. When the funnel reaches the top of the plant, the user performs two steps. First, button A on the wireless remote control is pressed, which activates the linear solenoid one, which in turn releases the two strings, which in turn releases the sleeve from the funnel. The fabric sleeve and funnel are only connected by the elastic drawstring at this point. Next, the user pulls upward slightly on the funnel, which causes the elastic drawstring to tighten and seal the top of the fabric sleeve. Finally, the user presses the B button on the wireless remote control which activates linear solenoid two and separates the funnel from the fabric sleeve. The funnel is lowered to the ground and the process is ready to be repeated.

### BRIEF DESCRIPTION OF DRAWINGS

FIG. 1 is a side view of an winter cover system for bamboo, with a sleeve connected.

FIG. 2 is merely illustrative, demonstrating the winter cover system for bamboo as it compresses the plant.

FIG. 3A depicts the bamboo plant before it has been covered.

FIG. 3B depicts the bamboo plant after it has been covered using the tool.

FIGS. 4A-E depict the tool at the top of the bamboo plant and the steps that detach the tool from the sleeve.

FIGS. 5A-D show the winter cover system for bamboo from four different sides.

FIG. 6 is an enlarged perspective view of the winter cover system for bamboo of FIG. 1 with enhanced detail of the sleeve detachment mechanism and the drawstring sealing mechanism. It depicts how a heating element such as Christmas lights can optionally be installed in the sleeve.

FIG. 7A is a close up view of the top of the sleeve, detailing the components of the sleeve.

FIG. 7B is a close up view of the top of the sleeve, showing in detail the hook and loop seam.

FIG. 8 is a close up view of the wireless remote control

### DETAILED DESCRIPTION OF INVENTION

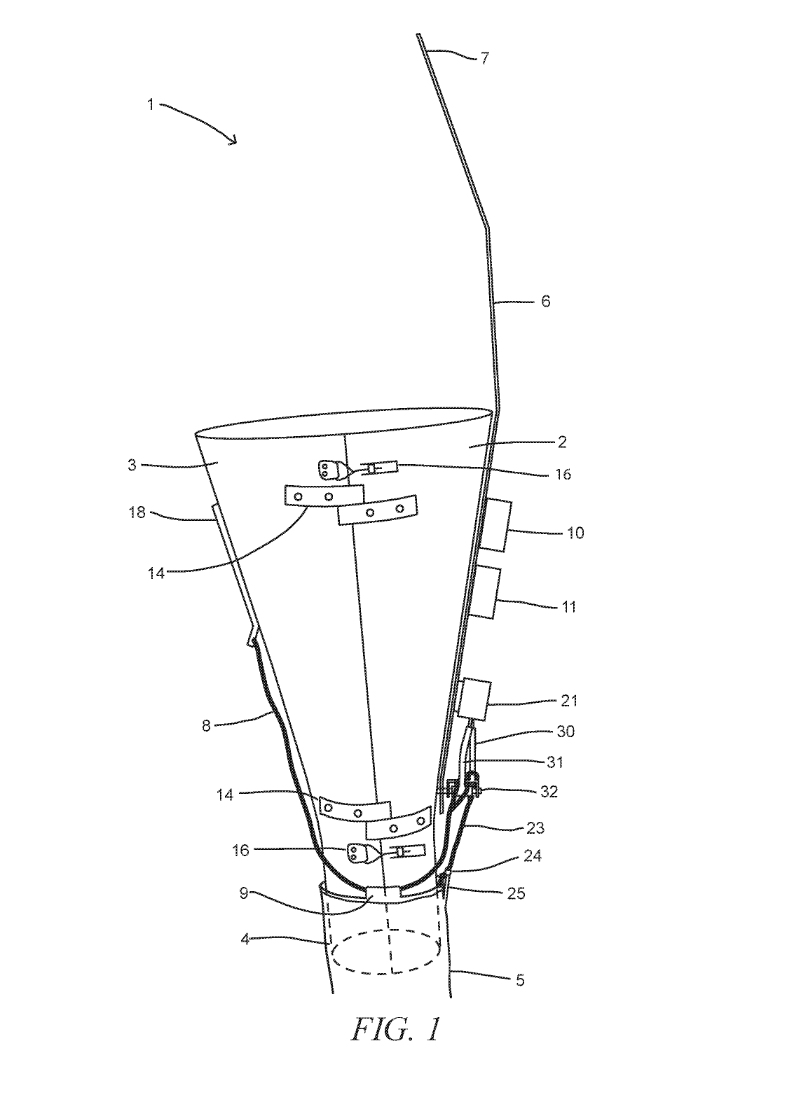

An embodiment of an winter cover system for bamboo is illustrated in FIGS. 1-8.

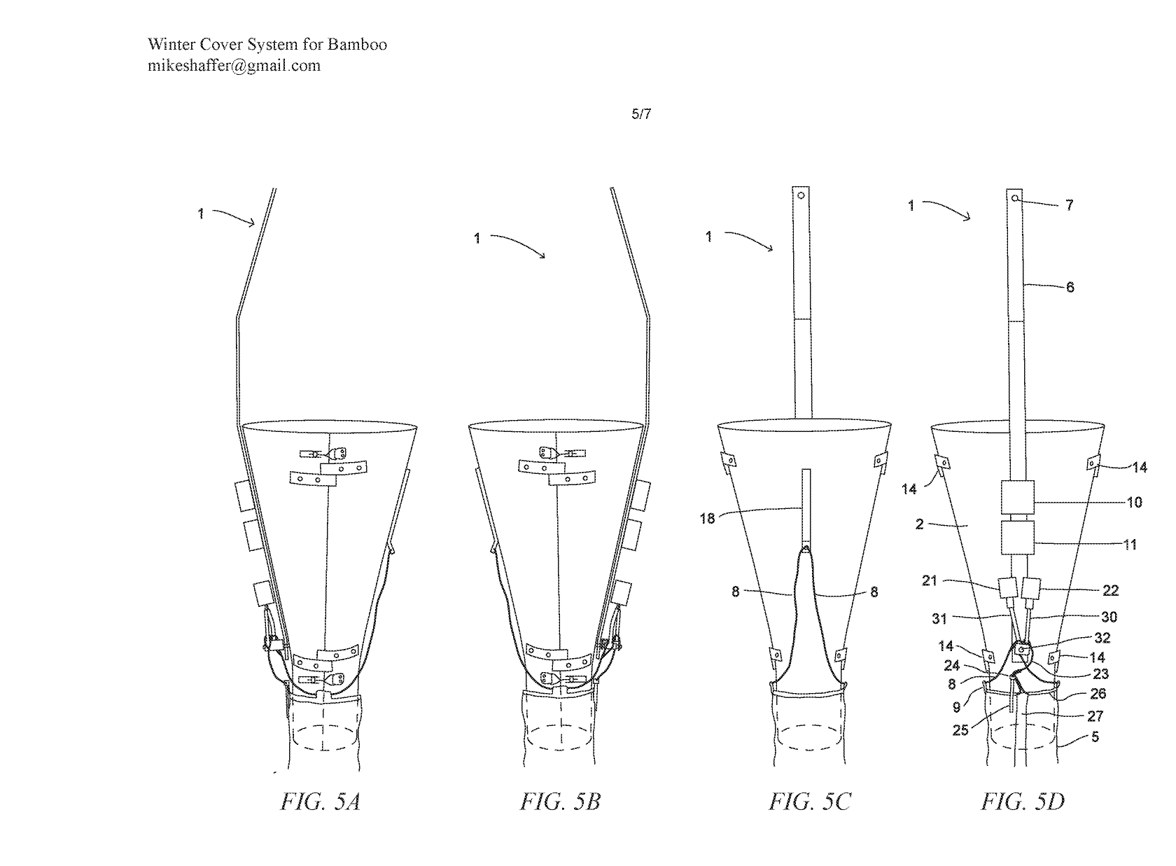

Referring primarily to FIGS. 1, 5A-D and 6, the system creates a unique way of covering a bamboo plant. A special funnel tool 1 is capable of being split into two halves and re-attached around a bamboo stem, In FIG. 1 the two halves are represented by the detachable side 2 and the fixed side 3. Four latches 16 allow the two sides to be separated then re-attached. The detachable side 2 is removed, placed around the bamboo cane and re-latched to the fixed side 3. It should be noted that the funnel tool 1 hangs by a rope which is anchored well above the bamboo grove on a pulley. The rope is connected at the top of the funnel tool 1 at a hole 7. A metal bar 6 acts as a spine on which everything else is mounted. Pairs of metal blocks 14 are mounted on the edges of the detachable side 2 and the fixed side 3. These metal blocks 14 keep the detachable side 2 and fixed side 3 from moving up-down relative to each other. The combination of the metal blocks 14 and latches 16 serves to keep the detachable side 2 and fixed side 3 in alignment and firmly connected.

Again referring to FIGS. 1, 5A-D and 6, once the funnel is clamped around the base of the bamboo, a fabric sleeve 5 is wrapped around the funnel base 4. The funnel base 4 has a diameter which is slightly smaller than the fabric sleeve 5, allowing the sleeve to fit over the funnel base 4. Before the funnel can be pulled upwards, it must be connected to the sleeve 5. The fabric sleeve 5 has two loops 9 which are sewn on. Two strings 8 are connected to the funnel tool and pass through these loops 9, acting to hold the sleeve 5. These strings 8 are anchored on the detachable 2 side by a metal bar 18 and on the fixed side 3 by a metal rod 31. Metal rod 31 is designed to move, which releases the strings 8 and separates the funnel tool from the sleeve 5.

Referring primarily to FIGS. 1, 5A-D, 6 and 8 the funnel tool 1 has a battery 10 and a wireless relay 11. These are for controlling linear solenoid 21 and linear solenoid 22. Linear solenoid 21 holds and releases strings 8 by releasing metal rod 31. Linear solenoid 22 holds and releases drawstring 23 by releasing metal rod 30. The wireless relay 11 responds to a wireless remote control 40 which has two buttons, A 41 and B 42, one for each radio channel.

Referring primarily to FIGS. 1, 5A-D and 6, an elastic drawstring 23 passes through a drawstring channel 26 around the end of the sleeve 5 and then passes through a slotted cord lock 24. The cord lock 24 is of the “slotted” type, which allows it to be attached to the end of the sleeve 5 by a short 2″ long strap 25. To cinch shut the drawstring 23 and associated drawstring channel 26 one must only pull up on the funnel tool 1.

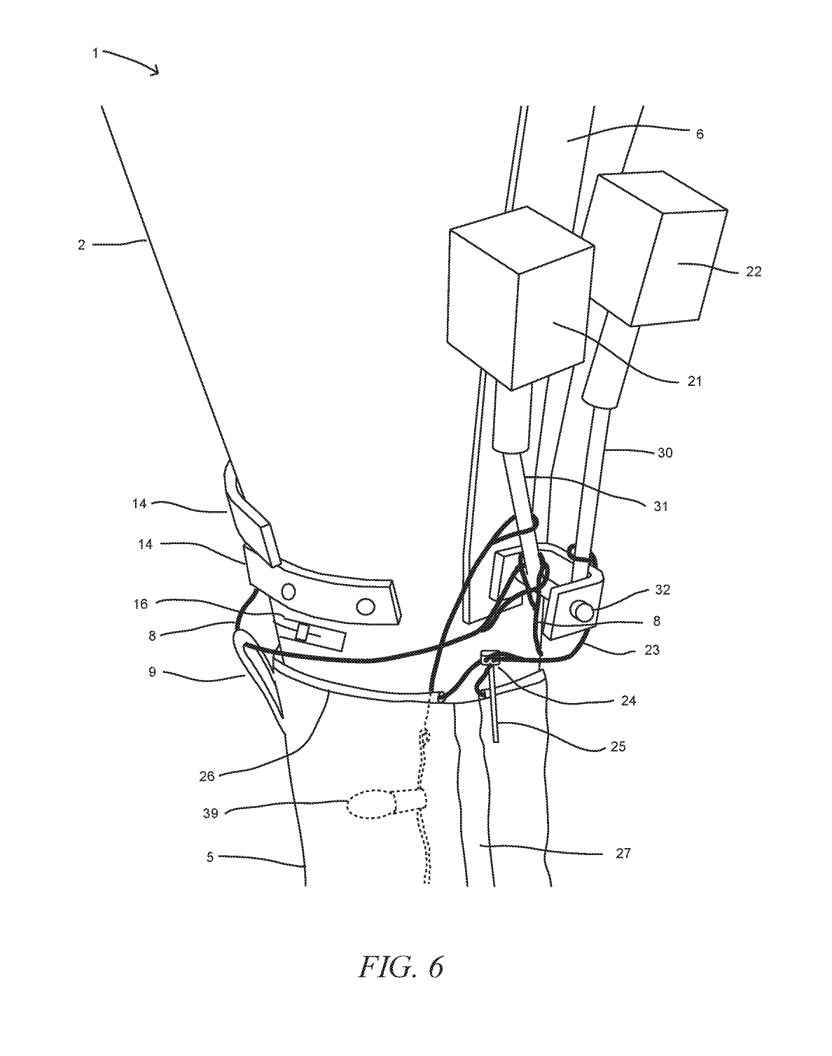

Referring primarily to FIG. 6, if the user wishes to install a heating element such as Christmas lights 39 into the sleeve, this is done by tying them with a short string to metal rod 31. When metal rod 31 is released, strings 8 will be released at the same time as the Christmas lights 39 or other heating element.

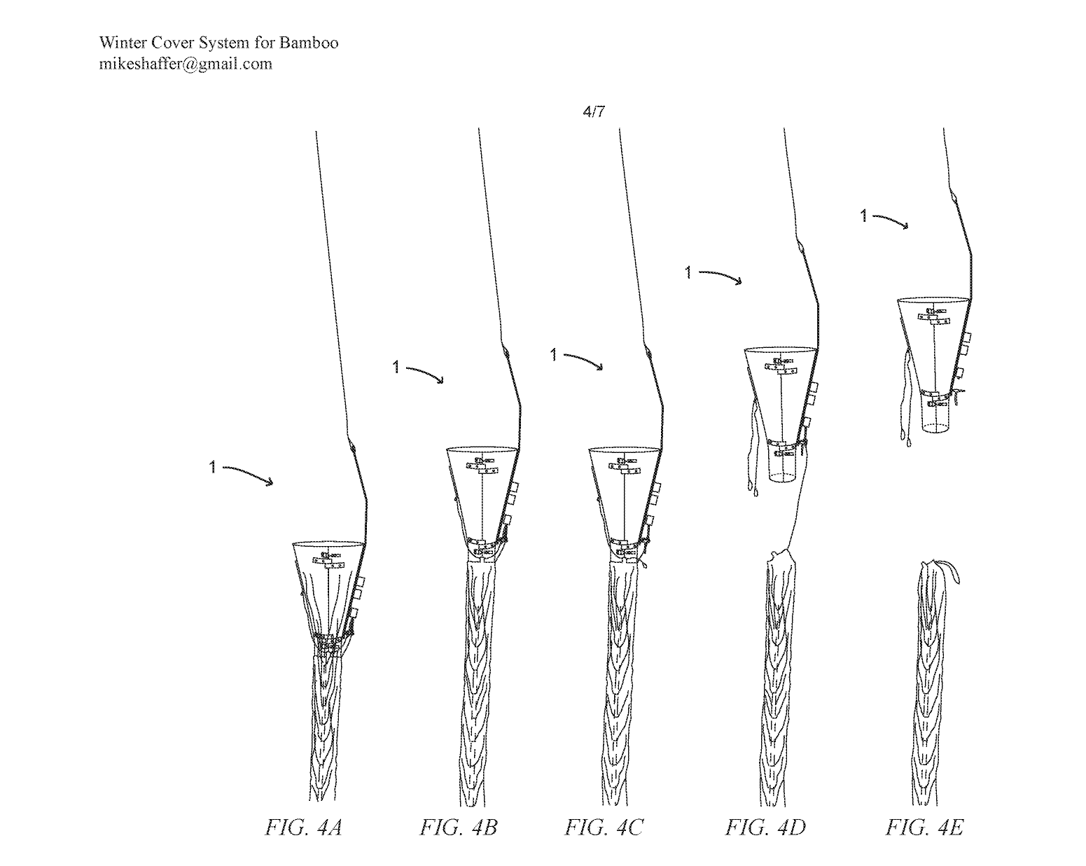

Referring primarily to FIGS. 4A-E, five views are shown which depict the steps that are performed when the funnel tool 1 reaches the tip of the bamboo plant. Referring to FIG. 4A, here, the funnel tool 1 is almost to the end of the plant. At this point, the user carefully pulls the funnel tool 1 up until the end of the sleeve is even with the tip of the bamboo, as depicted in FIG. 4B. Next, the user presses button A 41 on the wireless remote control 40. This activates solenoid 21 which releases metal rod 31 and allows it to rotate downward about bolt 32. This releases the two strings 8 which were looped around metal rod 31. FIG. 4C depicts the current arrangement. At this point, this user pulls the funnel tool 1 upwards about one foot, as depicted in FIG. 4D. When the funnel tool 1 is pulled up, two strings 8 are drawn through the two fabric loops 9 on the end of the sleeve 5. At this point the funnel tool 1 now becomes free from the sleeve, with the exception of the drawstring 23. At this point, the user again pulls the funnel tool 1 upwards another foot or so, which cinches shut drawstring channel 26. Next, the user then pushes button B 42 on the wireless remote control 40. This activates solenoid 22, which releases rod 30 and allows drawstring 23 to release. FIG. 4E depicts the final arrangement in which the bamboo is sealed in the sleeve 5 and the funnel tool 1 is no longer attached. Next, the funnel tool 1 is lowered to the ground and readied for the next bamboo stem to be protected.

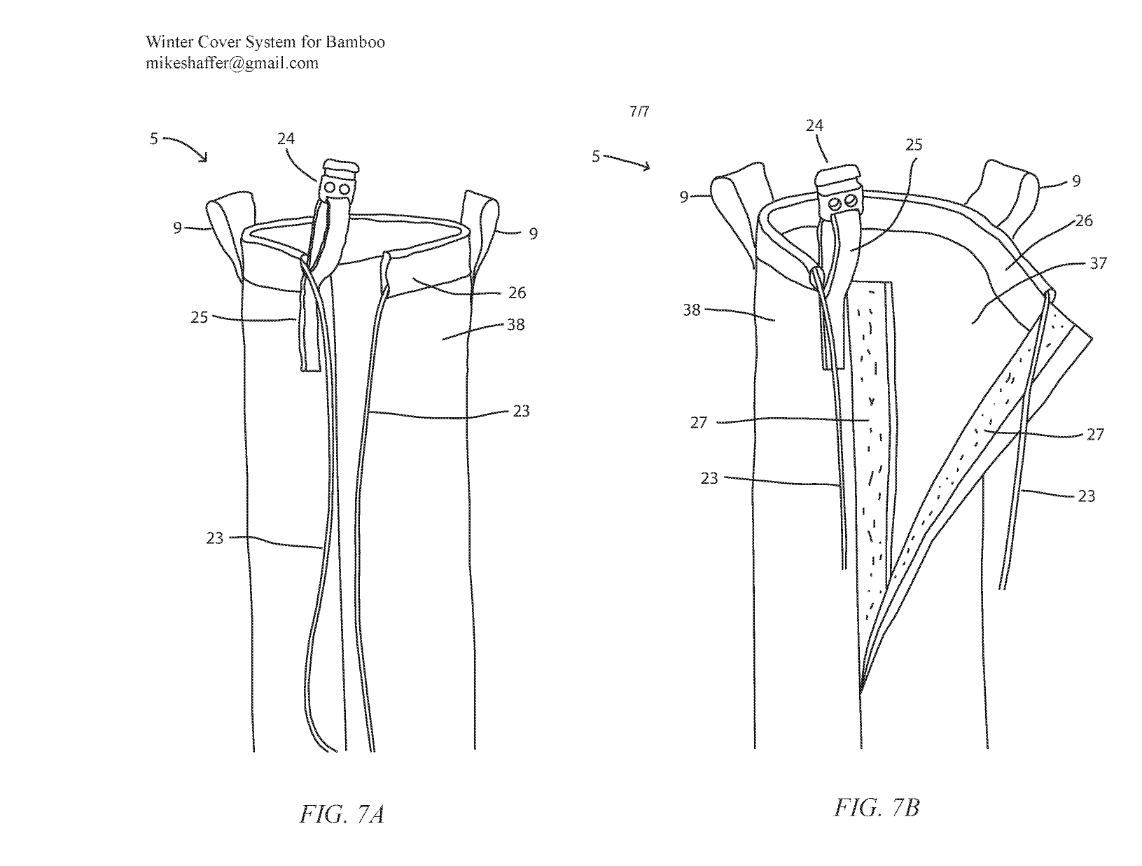

Referring primarily to FIGS. 7A and 7B, the fabric sleeve 5 has a strip of hook and loop 27 on both edges. The hook and loop is sewn on opposite sides of the fabric so that when the two edges are wrapped around the bamboo the hook and loop is positioned to be fastened onto itself. The fabric sleeve 5 has an inner layer 37 made of insulating fabric. The insulating fabric provides insulation and also enhances the strength of the outer layer 38. The outer layer 38 is made of ripstop nylon fabric. The ripstop nylon fabric 38 and insulating fabric 37 are sewn together approximately 5″ in from the sides of the sleeve 5 going the entire length of the sleeve 5. The ripstop nylon fabric 38 and insulating fabric 37 are also sewn together under the hook and loop at the edges. Again referring to FIGS. 7A and 7B, the cord lock 24 is visible which is connected to the sleeve 5 by a short strap 25. The elastic drawstring 23 can be seen passing through the drawstring channel 26. The two loops 9 which hold the sleeve to the funnel are also visible.

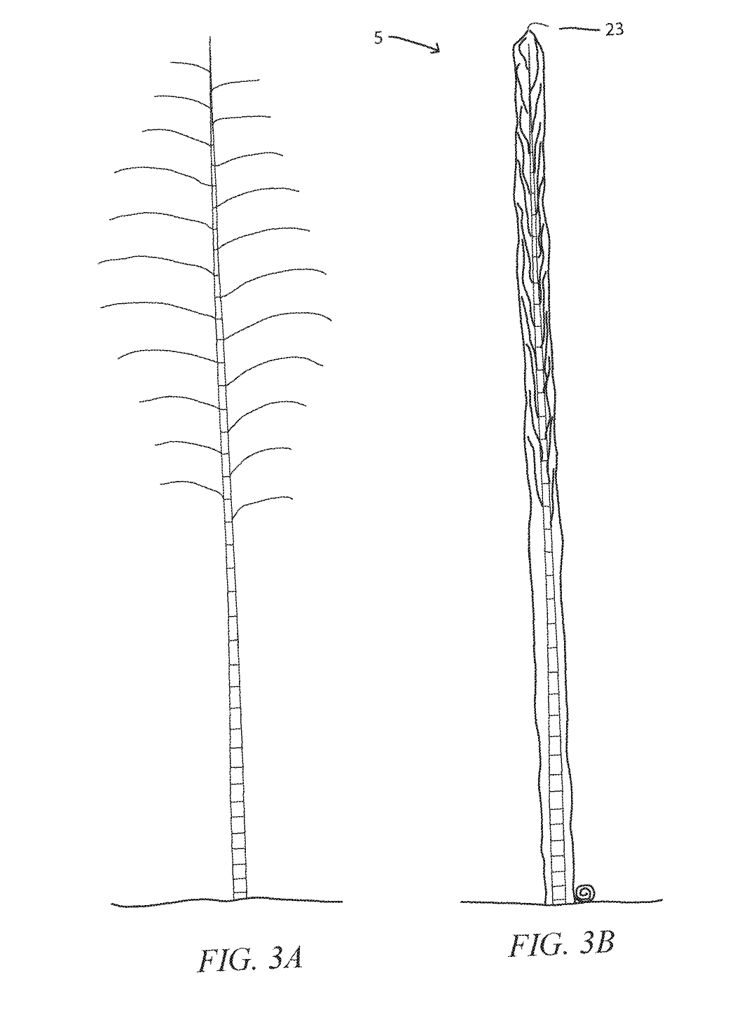

Referring to FIGS. 3A and 3B. FIG. 3A depicts before the bamboo plant has been covered. FIG. 3B shows the bamboo plant after the cover has been put on. Note in FIG. 3B where the excess sleeve material is rolled up at the base of the cane. Note also in FIG. 3B that the drawstring 23 is visible at the top of the cover 5.

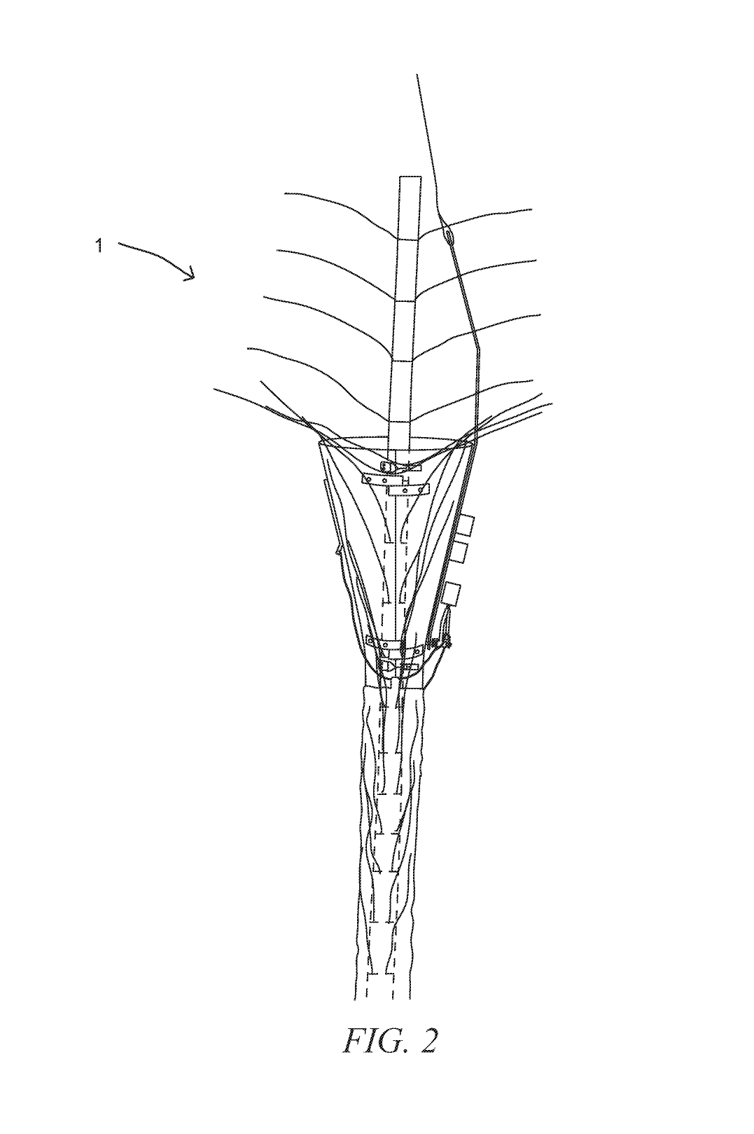

Referring to FIG. 2, a view is given that demonstrates how the funnel tool 1 compresses the bamboo plant.

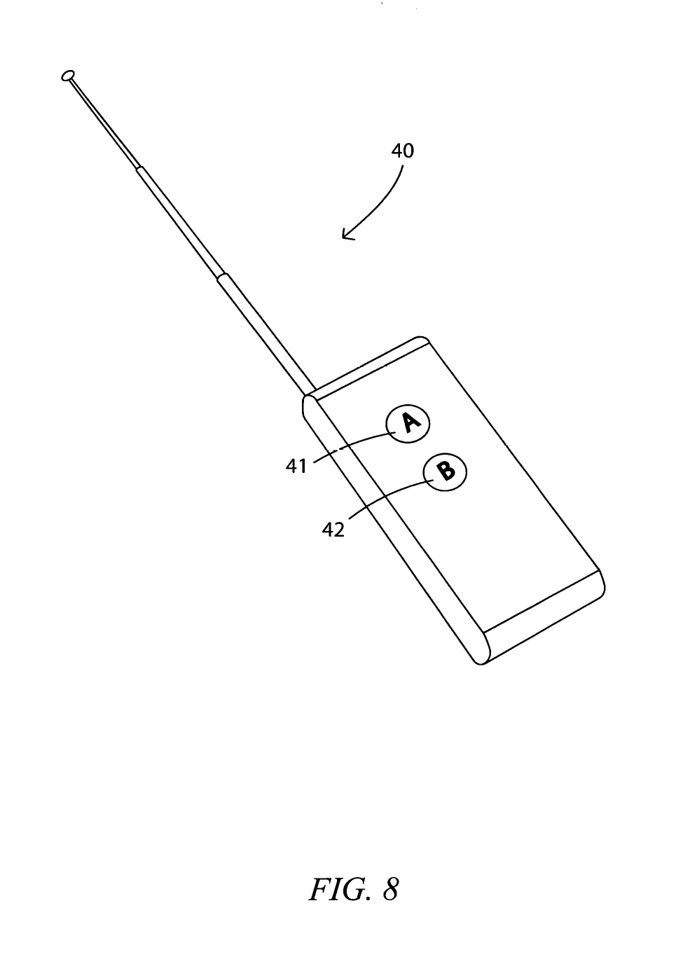

Referring to FIG. 8, a view is given of the wireless remote control 40 that controls the wireless relay 11. The wireless remote control 40 has two channels. Each channel has a button to turn it on and off. Button A 41 activates channel 1 and button B 42 activates channel 2.

The invention claimed is:

1. An winter cover system for bamboo plants, comprising:
a. a plastic funnel
b. said funnel is fabricated of optically clear plastic
c. said funnel is fabricated of rigid plastic
d. said funnel is split length-wise into two sides which are separated, placed around the bamboo stem, and re-joined with latches that are permanently attached to each side of the funnel
e. said funnel is straight at the bottom so that a tubular fabric sleeve can be slipped over it
f. said funnel has a metal bar permanently attached to one side for attaching a rope to said metal bar for lifting and lowering said funnel
g. said metal bar is permanently attached from just above the straight lower portion of the funnel to past the top of the funnel for approximately two feet
h. said funnel has a battery permanently attached to it
i. said funnel has a wireless relay permanently attached to it
j. said funnel has a wireless release mechanism permanently attached to it for separating said funnel from a temporarily attached fabric sleeve
k. said funnel has a wireless release mechanism permanently attached to it for sealing the drawstring on the end of the fabric sleeve and separating said fabric sleeve from said funnel
l. said release mechanisms are controlled by said wireless relay
m. said wireless relay and said remote release mechanisms are powered by said battery
n. said fabric sleeve has a top end which is designed to be temporarily connected to the lower end of said funnel and said fabric sleeve is designed to be releasable by said release mechanism
o. said fabric sleeve is comprised of an elastic drawstring permanently attached to its top end
p. said elastic drawstring is constructed to be temporarily connected to the lower end of said funnel and to be sealed and detached by said release mechanism
